(19) United States
(12) Patent Application Publication
(10) Pub. No.: US 2019/0051123 A1
(43) Pub. Date: Feb. 14, 2019

(54) GATEWAY DIAGNOSTICS USING SUBSYSTEM BASED LIGHT INDICATORS

(71) Applicant: ARRIS Enterprises LLC, Suwanee, GA (US)

(72) Inventor: Soma Sekhar Muppidi, Suwanee, GA (US)

(21) Appl. No.: 16/058,602

(22) Filed: Aug. 8, 2018

Related U.S. Application Data
(60) Provisional application No. 62/543,527, filed on Aug. 10, 2017.

(51) Int. Cl. G08B 5/36; G08B 5/38; H04L 12/24

(52) U.S. Cl. CPC G08B 5/36; H04L 41/06; G08B 5/38

(57) ABSTRACT

Methods, systems, and computer readable media can be operable to facilitate diagnostics reporting using subsystem based light indicators. A CPE device may include one or more light indicators such as LEDs. The CPE device may recognize an event or state associated with the CPE device or a network or device that is associated with the CPE device. The CPE device may map the recognized event or state to an associated combination of light indicator functions, and the CPE device may manipulate the one or more light indicators according to the associated combination of light indicator functions.

### CROSS REFERENCE TO RELATED APPLICATION

This application is a non-provisional application claiming the benefit of U.S. Provisional Application Ser. No. 62/543,527, entitled “Method and System for Gateway Diagnostics Using Subsystem Based LEDs,” which was filed on Aug. 10, 2017, and is incorporated herein by reference in its entirety.

### TECHNICAL FIELD

This disclosure relates to gateway diagnostics using subsystem based light indicators.

### BACKGROUND

In general, CPE (customer premise equipment) devices include a plurality of embedded subsystems. CPE devices may generate various events during the course of operation, and information concerning a variety of recognized events, states, and/or conditions associated with the CPE device and/or associated networks or devices may be generated by the sum total of these events. Knowledge of these events, states, and/or conditions would benefit users of the CPE device, installers, multiple systems operators, and others. Therefore, it is desirable to improve upon methods and systems for recognizing and providing notification of events, states, and/or conditions associated with the CPE device and/or associated networks or devices.

### BRIEF DESCRIPTION OF THE DRAWINGS

FIG. 1 is a block diagram illustrating an example network environment operable to facilitate diagnostics reporting using subsystem based light indicators.

FIG. 2 is a block diagram illustrating an example CPE device operable to facilitate diagnostics reporting using subsystem based light indicators.

FIG. 3 is a flowchart illustrating an example process operable to facilitate diagnostics reporting using subsystem based light indicators.

FIG. 4 is a flowchart illustrating an example process operable to facilitate an output of a communication comprising an identification of one or more LED functions associated with a recognized state or event.

FIG. 5 shows an example front elevation view of a CPE device having LEDs which may be manipulated to provide an indication of a recognized state or event.

FIG. 6 shows an example front elevation view of a CPE device having LEDs which may be manipulated to provide an indication of a recognized state or event.

FIG. 7 is a block diagram of a hardware configuration operable to facilitate diagnostics reporting using subsystem based light indicators.

Like reference numbers and designations in the various drawings indicate like elements.

### DETAILED DESCRIPTION

Methods, systems, and computer readable media can be operable to facilitate diagnostics reporting using subsystem based light indicators. A CPE device may include one or more light indicators such as LEDs. The CPE device may recognize an event or state associated with the CPE device or a network or device that is associated with the CPE device. The CPE device may map the recognized event or state to an associated combination of light indicator functions, and the CPE device may manipulate the one or more light indicators according to the associated combination of light indicator functions.

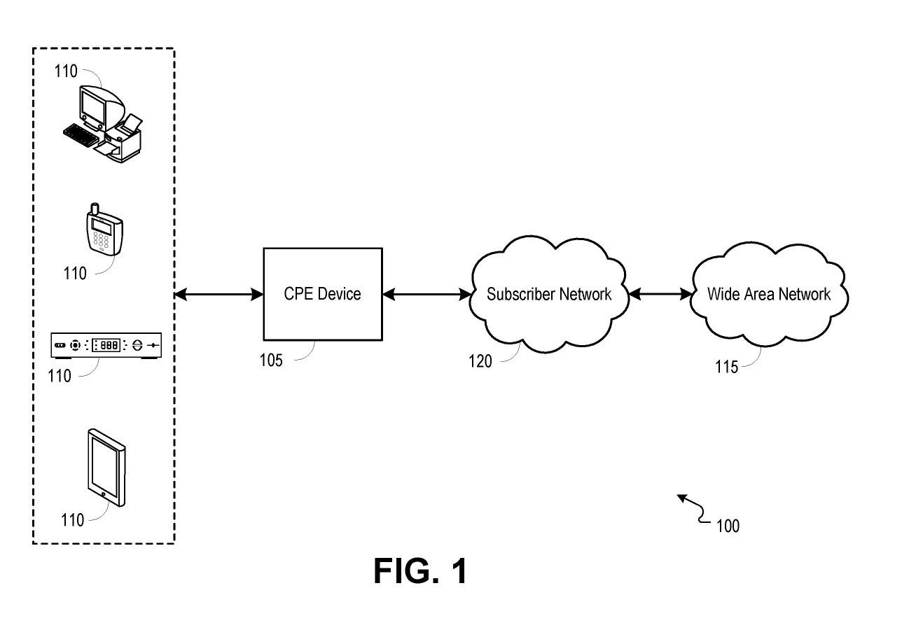

FIG. 1 is a block diagram illustrating an example network environment 100 operable to facilitate diagnostics reporting using subsystem based light indicators. In embodiments, a CPE (customer premise equipment) device 105 may provide one or more services (e.g., video services, data services, voice services, etc.) to one or more client devices 110. The CPE device 105 may include a gateway, a cable modem, a wireless router including an embedded cable modem, a mobile hot-spot router, a multimedia over coaxial alliance (MoCA) node, a wireless extender, and any access point or other device that is operable to provide one or more services to one or more client devices 110. The client devices 110 may include a wide variety of devices such as televisions, mobile devices, tablets, set-top boxes, computers, telephones, security devices, and any other device that is capable of utilizing a wireless video, data, telephony, or security service, or that is otherwise capable of transmitting and/or receiving wireless communications.

In embodiments, the CPE device 105 may route communications between client devices 110 and a WAN 115 via a subscriber network 120. The subscriber network 120 may include various networks such as Ethernet (e.g., CAT5/CAT6), coaxial cable, optical fiber, twisted pair network, satellite networks, mobile networks including 4G and LTE, and others.

In embodiments, the CPE device 105 may include one or more light indicators (e.g., LED (light emitting diode)). The CPE device 105 may be configured to recognize a state or event and to generate and output a notification or indication of the recognized state or event. For example, the state or event may be recognized by the CPE device 105 as a state or event occurring at the CPE device 105, at a client device 110, at a local area network (LAN) provided by the CPE device 105, or at an upstream network or element.

In embodiments, the CPE device 105 may generate and output a notification or indication of a recognized state or event by manipulating the one or more light indicators. Manipulation of the one or more light indicators may be achieved using a state machine based design and multiple LED colors and variable blink rate patterns to provide a unique LED interface. As an example, multiple colors (e.g., red, blue, white, green, etc.) LED colors may be used to illuminate each of one or more LEDs of the CPE device 105, and multiple different variable blink rate patterns may be utilized by one or more LEDs of the CPE device 105 (e.g., fast blink rate (3 cycles per second), slow blink rate (1 cycle per second), etc.). Using these combinations of LED colors and LED blink rates, an LED information element may be utilized to encode a wide range of operational events that are encountered during the design and course of operation of the CPE device 105.

In embodiments, the CPE device 105 may manipulate one or more functions associated with each of one or more LEDs. For example, the functions of an LED that may be manipulated by the CPE device 105 may include a color of the illuminated LED, a blink rate (e.g., a frequency at which the LED is illuminated), and a state of illumination (e.g., whether the LED is on/off, illuminated/not illuminated). The CPE device 105 may be configured with a map that associates each of one or more states or events with functions of one or more LEDs.

In embodiments, the CPE device 105 may be configured to associate each of one or more states or events with a triple (3-tuple) encoded information element {LED color, state, blink rate}. The triple encoded information element may be utilized by the CPE device 105 to manipulate each of one or more LEDs. In embodiments, the CPE device 105 may output a communication to another device (e.g., an upstream device or server, a client device 110 such as a mobile device, etc.), and the communication may include an identification of, or information that may be used to identify, a state or event. For example, the communication may include a triple encoded information element that is associated with a recognized state or event. The other device may identify a state or event associated with the triple encoded information element by mapping the triple encoded information element to an associated state or event.

In embodiments, the CPE device 105 may be configured to interface with mobile application that is run on a client device 105 such as a mobile device or tablet. For example, the CPE device 105 may output a triple encoded information element to the mobile application (e.g., to a server controlling the mobile application) and the mobile application may identify a state or event that is associated with the triple encoded information element. It should be understood that APIs (application program interface) may retrieve the triple encoded information element and may be interfaced with customer SNMP MIBs.

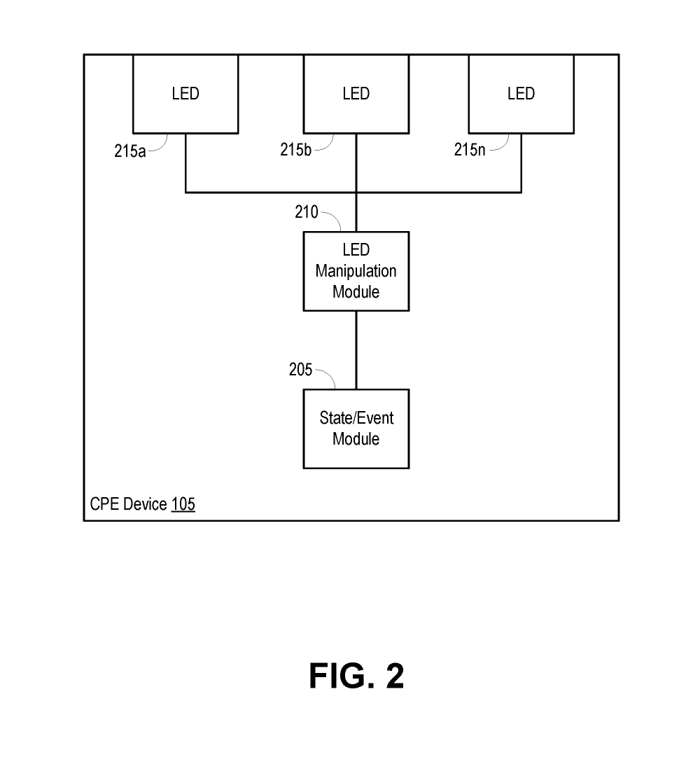

FIG. 2 is a block diagram illustrating an example CPE device 105 operable to facilitate diagnostics reporting using subsystem based light indicators. The CPE device 105 may include a state/event module 205, an LED manipulation module 210, and one or more LEDs 215a-n.

In embodiments, the state/event module 205 may be configured to recognize a state or event and to generate and output a notification or indication of the recognized state or event. For example, the state or event may be recognized by the state/event module 205 as a state or event occurring at the CPE device 105, at a client device 110 of FIG. 1, at a local area network (LAN) provided by the CPE device 105, or at an upstream network or element.

In embodiments, the state/event module 205 may notify the LED manipulation module 210 of the recognized state/event, and the LED manipulation module 210 may generate and output a notification or indication of the recognized state or event by manipulating the one or more LEDs 215a-n. The LED manipulation module 210 may map the recognized state/event to an associated combination of LED functions. In embodiments, according to the combination of LED functions associated with the recognized state/event, the LED manipulation module 210 may manipulate one or more functions associated with each of one or more LEDs 215a-n. For example, the functions of an LED 215a-n that may be manipulated by the LED manipulation module 210 may include a color of the illuminated LED (e.g., red, blue, white, green, etc.), a blink rate (e.g., a frequency at which the LED is illuminated), and a state of illumination (e.g., whether the LED is on/off, illuminated/not illuminated). The CPE device 105 may be configured with a map that associates each of one or more states or events with functions of one or more LEDs, and the LED manipulation module 210 may utilize the map to identify functions to be implemented at the LEDs 215a-n.

In embodiments, the state/event module 205 may be configured to associate each of one or more states or events with a triple (3-tuple) encoded information element {LED color, state, blink rate}. The triple encoded information element may be utilized by the LED manipulation module 210 to manipulate each of one or more LEDs 215a-n. In embodiments, the state/event module 205 may output a communication to another device (e.g., an upstream device or server, a client device 110 such as a mobile device, etc.), and the communication may include an identification of, or information that may be used to identify, a state or event. For example, the communication may include a triple encoded information element that is associated with a recognized state or event. The other device may identify a state or event associated with the triple encoded information element by mapping the triple encoded information element to an associated state or event.

In embodiments, the one or more LED functions associated with the recognized state or event may include one or more LED functions associated with each respective one LED of the one or more LEDs 215a-n, and wherein the one or more LED functions associated with a respective one LED of the one or more LEDs 215a-n include a color of illumination, a blink rate, and a state of illumination.

In embodiments, the one or more LED functions associated with the recognized state or event may be stored at the CPE device 105 as a grouping of triple encoded information elements, wherein each respective triple encoded information element comprises an identification of the one or more LED functions associated with a respective LED of the one or more LEDs 215a-n.

In embodiments, the state/event module 205 may be configured to interface with a mobile application that is run on a client device 105 such as a mobile device or tablet. For example, the state/event module 205 may output a triple encoded information element to the mobile application (e.g., to a server controlling the mobile application) and the mobile application may identify a state or event that is associated with the triple encoded information element.

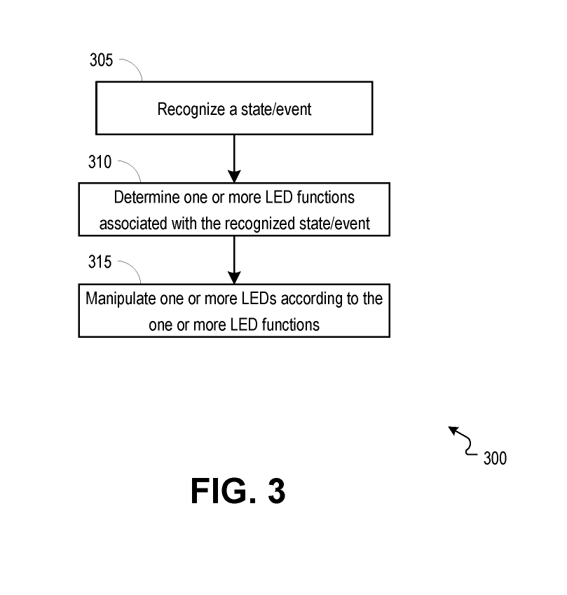

FIG. 3 is a flowchart illustrating an example process 300 operable to facilitate diagnostics reporting using subsystem based light indicators. In embodiments, the process 300 may be carried out by a CPE device 105 of FIG. 1. The process 300 may start at 305, when a state or event is recognized. The state or event may be recognized, for example, by the CPE device 105 (e.g., by a state/event module 205 of FIG. 2). In embodiments, the state or event may be recognized by the state/event module 205 as a state or event occurring at the CPE device 105, at a client device 110 of FIG. 1, at a local area network (LAN) provided by the CPE device 105, or at an upstream network or element.

At 310, one or more LED functions associated with the recognized state or event may be determined. The one or more LED functions associated with the recognized state or event may be determined, for example, by the CPE device 105 (e.g., by an LED manipulation module 210). In embodiments, the LED manipulation module 210 may map the recognized state/event to an associated combination of LED functions. For example, the CPE device 105 may be configured with a map that associates each of one or more states or events with functions of one or more LEDs. The one or more LED functions associated with the recognized state or event may include one or more LED functions associated with each of one or more LEDs that are associated with the CPE device 105, and the LED functions associated with each respective LED may control the operation of the respective LED. Functions of an LED may include a color of the illuminated LED (e.g., red, blue, white, green, etc.), a blink rate (e.g., a frequency at which the LED is illuminated), and a state of illumination (e.g., whether the LED is on/off, illuminated/not illuminated).

At 315, one or more LEDs may be manipulated according to the one or more LED functions. The one or more LEDs (e.g., LEDs 215a-n of FIG. 2) may be manipulated, for example, by the CPE device 105 (e.g., by the LED manipulation module 210). In embodiments, according to the combination of LED functions associated with the recognized state/event (e.g., the combination of LED functions determined at 310), the LED manipulation module 210 may manipulate one or more functions associated with each of one or more LEDs 215a-n. The LED manipulation module 210 may manipulate the operation of the one or more LEDs 215a-n according to the LED functions associated with the recognized state/event. For example, the functions of an LED 215a-n that may be manipulated by the LED manipulation module 210 may include a color of the illuminated LED (e.g., red, blue, white, green, etc.), a blink rate (e.g., a frequency at which the LED is illuminated), and a state of illumination (e.g., whether the LED is on/off, illuminated/not illuminated).

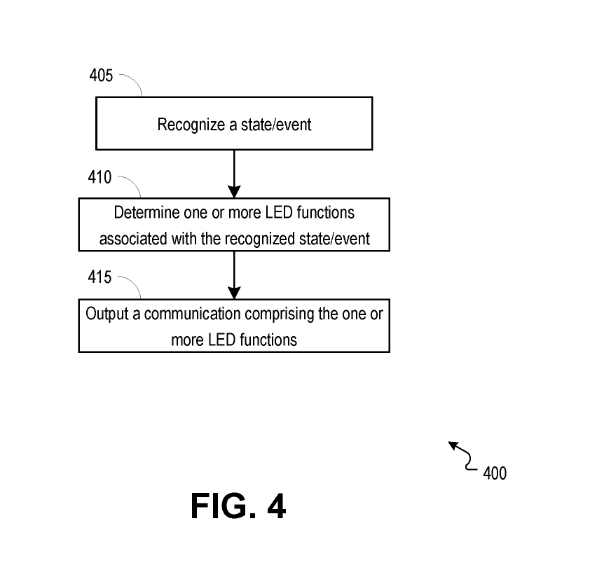

FIG. 4 is a flowchart illustrating an example process 400 operable to facilitate an output of a communication comprising an identification of one or more LED functions associated with a recognized state or event. In embodiments, the process 400 may be carried out by a CPE device 105 of FIG. 1. The process 400 may start at 405, when a state or event is recognized. The state or event may be recognized, for example, by the CPE device 105 (e.g., by a state/event module 205 of FIG. 2). In embodiments, the state or event may be recognized by the state/event module 205 as a state or event occurring at the CPE device 105, at a client device 110 of FIG. 1, at a local area network (LAN) provided by the CPE device 105, or at an upstream network or element.

At 410, one or more LED functions associated with the recognized state or event may be determined. The one or more LED functions associated with the recognized state or event may be determined, for example, by the CPE device 105 (e.g., by an LED manipulation module 210). In embodiments, the LED manipulation module 210 may map the recognized state/event to an associated combination of LED functions. For example, the CPE device 105 may be configured with a map that associates each of one or more states or events with functions of one or more LEDs. Functions of an LED may include a color of the illuminated LED (e.g., red, blue, white, green, etc.), a blink rate (e.g., a frequency at which the LED is illuminated), and a state of illumination (e.g., whether the LED is on/off, illuminated/not illuminated).

At 415, a communication comprising an identification of the one or more LED functions may be output. The communication may be output, for example, by the CPE device 105 (e.g., by the state/event module 205 of FIG. 2), and the communication may be output to another device such as a device that is upstream from the CPE device 105, a client device 110 of FIG. 1, a mobile application, or other device or server. In embodiments, the state/event module 205 may be configured to associate each of one or more states or events with a triple (3-tuple) encoded information element {LED color, state, blink rate}. The communication output by the state/event module 205 may include an identification of, or information that may be used to identify, the recognized state or event (e.g., the state or event recognized at 405). For example, the communication may include a triple encoded information element that is associated with a recognized state or event (e.g., the triple encoded information element may include an identification of the one or more LED functions associated with the recognized state/event as determined at 410). The other device may identify a state or event associated with the triple encoded information element by mapping the triple encoded information element to an associated state or event.

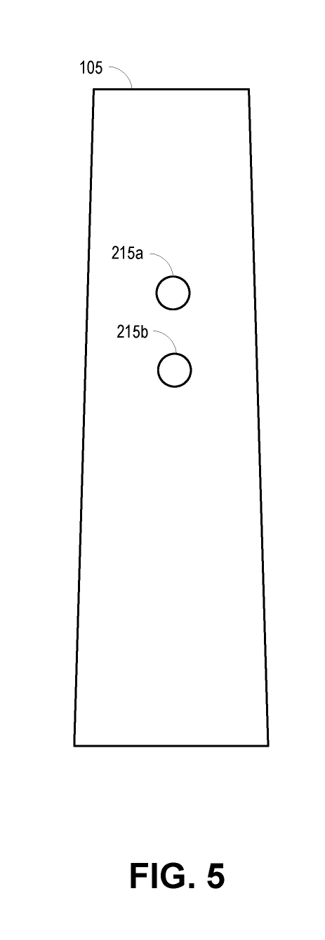

FIG. 5 shows an example front elevation view of a CPE device 105 having LEDs 215a-b which may be manipulated to provide an indication of a recognized state or event. In embodiments, one or more functions associated with each of the LEDs 215a-b may be manipulated in response to a recognized state or event. The CPE device 105 may map a recognized state or event to an associated combination of LED functions, and the CPE device 105 may manipulate the operation of the LEDs 215a-b according to the associated combination of LED functions. For example, the LED functions that may be manipulated may include a color of the illuminated LED (e.g., red, blue, white, green, etc.), a blink rate (e.g., a frequency at which the LED is illuminated), and a state of illumination (e.g., whether the LED is on/off, illuminated/not illuminated)

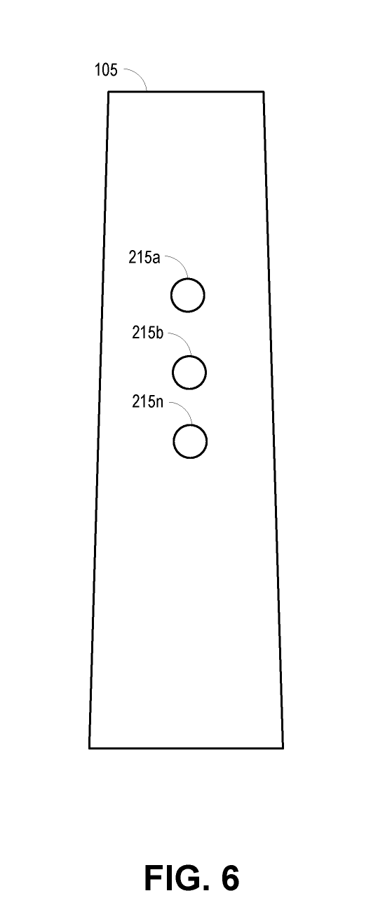

FIG. 6 shows an example front elevation view of a CPE device 105 having LEDs 215a-n which may be manipulated to provide an indication of a recognized state or event. In embodiments, one or more functions associated with each of the LEDs 215a-n may be manipulated in response to a recognized state or event. The CPE device 105 may map a recognized state or event to an associated combination of LED functions, and the CPE device 105 may manipulate the operation of the LEDs 215a-n according to the associated combination of LED functions. For example, the LED functions that may be manipulated may include a color of the illuminated LED (e.g., red, blue, white, green, etc.), a blink rate (e.g., a frequency at which the LED is illuminated), and a state of illumination (e.g., whether the LED is on/off, illuminated/not illuminated).

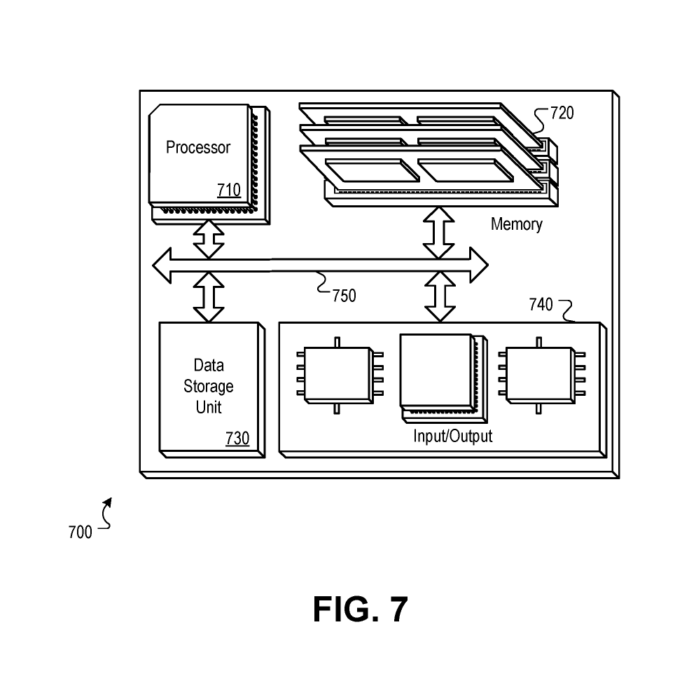

FIG. 7 is a block diagram of a hardware configuration 700 operable to facilitate diagnostics reporting using subsystem based light indicators. It should be understood that the hardware configuration 700 can exist in various types of devices. The hardware configuration 700 can include a processor 710, a memory 720, a storage device 730, and an input/output device 740. Each of the components 710, 720, 730, and 740 can, for example, be interconnected using a system bus 750. The processor 710 can be capable of processing instructions for execution within the hardware configuration 700. In one implementation, the processor 710 can be a single-threaded processor. In another implementation, the processor 710 can be a multi-threaded processor. The processor 710 can be capable of processing instructions stored in the memory 720 or on the storage device 730.

The memory 720 can store information within the hardware configuration 700. In one implementation, the memory 720 can be a computer-readable medium. In one implementation, the memory 720 can be a volatile memory unit. In another implementation, the memory 720 can be a non-volatile memory unit.

In some implementations, the storage device 730 can be capable of providing mass storage for the hardware configuration 700. In one implementation, the storage device 730 can be a computer-readable medium. In various different implementations, the storage device 730 can, for example, include a hard disk device, an optical disk device, flash memory or some other large capacity storage device. In other implementations, the storage device 730 can be a device external to the hardware configuration 700.

The input/output device 740 provides input/output operations for the hardware configuration 700. In embodiments, the input/output device 740 can include one or more of a network interface device (e.g., an Ethernet card), a serial communication device (e.g., an RS-232 port), one or more universal serial bus (USB) interfaces (e.g., a USB 2.0 port) and/or a wireless interface device (e.g., an 802.11 card). In embodiments, the input/output device can include driver devices configured to send communications to, and receive communications from one or more networks (e.g., subscriber network 120 of FIG. 1, WAN 115 of FIG. 1, local network, etc.) and/or one or more access devices (e.g., access devices 105 of FIG. 1) and/or stations (e.g., stations 110 of FIG. 1).

Those skilled in the art will appreciate that the invention improves upon methods and systems for recognizing and providing notification of events or states occurring at a CPE device or an associated network or device. Methods, systems, and computer readable media can be operable to facilitate diagnostics reporting using subsystem based light indicators. A CPE device may include one or more light indicators such as LEDs. The CPE device may recognize an event or state associated with the CPE device or a network or device that is associated with the CPE device. The CPE device may map the recognized event or state to an associated combination of light indicator functions, and the CPE device may manipulate the one or more light indicators according to the associated combination of light indicator functions.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
recognizing a state or event associated with a CPE device;
determining one or more LED functions associated with the recognized state or event; and
manipulating one or more LEDs of the CPE device according to the one or more LED functions associated with the recognized state or event.

2. The method of claim 1, further comprising:
outputting a communication comprising an identification of the one or more LED functions associated with the recognized state or event.

3. The method of claim 1, wherein determining the one or more LED functions associated with the recognized state or event comprises mapping the recognized state or event to the one or more LED functions associated with the recognized state or event.

4. The method of claim 1, wherein the one or more LED functions associated with the recognized state or event comprise one or more LED functions associated with each of one or more LEDs associated with the CPE device, wherein the one or more LED functions associated with each respective one LED of the one or more LEDs associated with the CPE device control an operation of the respective one LED.

5. The method of claim 1, wherein the one or more LED functions associated with the recognized state or event comprise one or more LED functions associated with each respective one LED of one or more LEDs associated with the CPE device, and wherein the one or more LED functions associated with a respective one LED of the one or more LEDs associated with the CPE device comprise a color of illumination, a blink rate, and a state of illumination.

6. The method of claim 1, wherein the one or more LED functions associated with the recognized state or event comprise one or more LED functions associated with each respective one LED of one or more LEDs associated with the CPE device, and wherein the one or more LED functions associated with the recognized state or event are stored as a grouping of triple encoded information elements, wherein each respective triple encoded information element comprises an identification of the one or more LED functions associated with an LED corresponding with the respective triple encoded information element.

7. The method of claim 1, wherein the recognized state or event is associated with a network that is associated with the CPE device.

8. A CPE device comprising:
one or more LEDs;
a state or event module that recognizes a state or event associated with the CPE device; and
an LED manipulation module that:
determines one or more LED functions associated with the recognized state or event; and
manipulates the one or more LEDs according to the one or more LED functions associated with the recognized state or event.

9. The CPE device of claim 8, wherein the state or event module further:
outputs a communication comprising an identification of the one or more LED functions associated with the recognized state or event.

10. The CPE device of claim 8, wherein determining the one or more LED functions associated with the recognized state or event comprises mapping the recognized state or event to the one or more LED functions associated with the recognized state or event.

11. The CPE device of claim 8, wherein the one or more LED functions associated with the recognized state or event comprise one or more LED functions associated with each of the one or more LEDs, wherein the one or more LED functions associated with each respective one LED of the one or more LEDs control an operation of the respective one LED.

12. The CPE device of claim 8, wherein the one or more LED functions associated with the recognized state or event comprise one or more LED functions associated with each respective one LED of the one or more LEDs, and wherein the one or more LED functions associated with a respective one LED of the one or more LEDs comprise a color of illumination, a blink rate, and a state of illumination.

13. The CPE device of claim 8, wherein the one or more LED functions associated with the recognized state or event comprise one or more LED functions associated with each respective one LED of the one or more LEDs, and wherein the one or more LED functions associated with the recognized state or event are stored as a grouping of triple encoded information elements, wherein each respective triple encoded information element comprises an identification of the one or more LED functions associated with an LED corresponding with the respective triple encoded information element.

14. One or more non-transitory computer readable media having instructions operable to cause one or more processors to perform the operations comprising:
recognizing a state or event associated with a CPE device;
determining one or more LED functions associated with the recognized state or event; and
manipulating one or more LEDs of the CPE device according to the one or more LED functions associated with the recognized state or event.

15. The one or more non-transitory computer-readable media of claim 14, wherein the instructions are further operable to cause the one or more processors to perform the operations comprising:
outputting a communication comprising an identification of the one or more LED functions associated with the recognized state or event.

16. The one or more non-transitory computer-readable media of claim 14, wherein determining the one or more LED functions associated with the recognized state or event comprises mapping the recognized state or event to the one or more LED functions associated with the recognized state or event.

17. The one or more non-transitory computer-readable media of claim 14, wherein the one or more LED functions associated with the recognized state or event comprise one or more LED functions associated with each of one or more LEDs associated with the CPE device, wherein the one or more LED functions associated with each respective one LED of the one or more LEDs associated with the CPE device control an operation of the respective one LED.

18. The one or more non-transitory computer-readable media of claim 14, wherein the one or more LED functions associated with the recognized state or event comprise one or more LED functions associated with each respective one LED of one or more LEDs associated with the CPE device, and wherein the one or more LED functions associated with a respective one LED of the one or more LEDs associated with the CPE device comprise a color of illumination, a blink rate, and a state of illumination.

19. The one or more non-transitory computer-readable media of claim 14, wherein the one or more LED functions associated with the recognized state or event comprise one or more LED functions associated with each respective one LED of one or more LEDs associated with the CPE device, and wherein the one or more LED functions associated with the recognized state or event are stored as a grouping of triple encoded information elements, wherein each respective triple encoded information element comprises an identification of the one or more LED functions associated with an LED corresponding with the respective triple encoded information element.

20. The one or more non-transitory computer-readable media of claim 14, wherein the recognized state or event is associated with a network that is associated with the CPE device.
